(19) United States
(12) Patent Application Publication
(10) Pub. No.: US 2011/0031797 A1
(43) Pub. Date: Feb. 10, 2011

(54) Assembled Product and Garden Chair

(75) Inventor: Zhengyi Lei, Guangdong (CN)

Correspondence Address: GLOBAL IP SERVICES, 7285 W. Eagle Court, Winton, CA, 95388, US

(73) Assignee: SHENZHEN BAOTESHI PRODUCTS PLUS CO., LTD., Shenzhen, Guangdong (CN)

(21) Appl. No.: 12/988,296

(22) PCT Filed: Apr. 15, 2009
(86) PCT No.: PCT/CN2009/071276

§ 371 Date: Oct. 15, 2010

(30) Foreign Application Priority Data
Apr. 16, 2008 (CN) 200820046478

(51) Int. Cl. A47C 3/00; A47C 7/54; F16B 12/10

(52) U.S. Cl. 297/411.2; 297/451.8; 428/44

(57) ABSTRACT

The invention provides an assembled product, comprising a main body, and a left part and right part which are of the same construction and symmetrically mounted to the main body. Each left and right parts have a connecting hole defined therein for engaging the respective connecting holes defined inside the main body. The invention also provides a garden chair, comprising a seating plate; a backrest arranged at one side of and connected with the seating plate; a pair of left and right front legs coupled with the seating plate symmetrically and respectively; and a pair of left and right rear legs which are coupled with the seating plate symmetrically and respectively. The product of the invention can be widely applicable to kinds of furniture.

### BACKGROUND OF THE INVENTION

1. Field of the Invention

The present invention relates to an assembled product and more particularly, to a product which is of symmetrical construction and thus capable of being readily assembled together and also relates to an assembled garden chair.

2. The Related Art

Assembled product such as assembled furniture is one of the necessary commodities in people's everyday life. Furniture with kinds of construction, types and uses emerge to meet different needs of consumers. Generally, the furniture is manufactured by furniture manufacturers. After that, the furniture is divided into several parts and finally these divided parts are delivered to the marketplace for sale.

However, during production and assembly processes of the furniture with widthwise symmetrical construction, the production efficiency is oftentimes decreased due to production unbalance between the left part and right part. Furthermore, it also become impossible for the end consumer to assemble the final product, because the completely identical components such as the legs or armrests are packaged and sold to the consumer by mistake of the workers during packaging process.

Accordingly, it is strongly desired at present to overcome difficulties in assembly of the symmetrical left and right parts resulted from production and transportation of the product, in particular the furniture.

### SUMMARY OF THE INVENTION

An object of the present invention is to provide an assembled product and a garden chair so as to address technical problems such as assembling difficulty and reduction of production efficiency caused by inconsistency in shape of the left and right parts of the assembled product in particular the furniture.

To arrive at the aforementioned object, the present invention provides an assembled product which comprises a main body, and a left part and right part which are of the same construction and symmetrically mounted to the main body. Each left and right parts have connecting holes defined therein for engaging the respective connecting holes defined inside the main body.

Preferably, the left or right part has connecting holes corresponding to the connecting holes defined both side of the main body. If the connecting holes are through holes located on a middle line in thickness direction of the left or right part, the left or right part is a symmetrical part to the middle line along thickness direction. If the connecting holes are blind holes, the left or right part is a symmetrical part to the middle line along length direction. Thereby, the left part and right part can be exchange without worrying the positions of connecting holes.

In addition, the invention also relates to an assembled garden chair. The assembled garden chair comprises a seating plate; a backrest assembled with the seating plate; a pair of left and right front legs with an identical construction being assembled with both sides of the seating plate; a pair of left and right rear legs with an identical construction being assembled with both sides of the seating plate; the left and right front legs each has through connecting holes located on a middle line along thickness direction of the left or right front leg, and the left or right front leg is a symmetrical leg to a middle line along thickness direction; the left and right rear legs each has through connecting holes located on a middle line along thickness direction of the left or right rear leg, and the left or right rear leg is a symmetrical leg to a middle line along thickness direction.

More preferably, the garden chair of the invention also includes a pair of left and right armrests which are of the identical configuration and coupled symmetrically between the seating plate and backrest. the left and right armrests each has blind connecting holes defined therein, the left or right armrest are symmetrical armrests to a middle line along length direction of the left or right armrest. Or, the left and right armrests each has through connecting holes located on a middle line along thickness direction of the left or right armrest, and the left or right armrest is a symmetrical armrest to a middle line along thickness direction.

Compared with prior art, the present invention can obtain the following advantages.

Because the left part and right part have the identical configuration and are mounted at two sides of the main body symmetrically; and meanwhile, the connecting holes of the left and right parts are engaged with respective holes defined in corresponding locations of the main body; therefore, the left and right parts are interchangeable with each other and thus, can be assembled onto the main body with ease. As a result, the assembled product in particular the furniture can be readily assembled as an entire product, hence improving production efficiency of the product especially the furniture.

### BRIEF DESCRIPTION OF THE DRAWINGS

The present invention will be apparent to those skilled in the art by reading the following description of a preferred embodiment thereof, with reference to the accompanying drawings, in which:

FIG. 1 is a schematic view of the construction of a preferred embodiment of the invention.

### DETAILED DESCRIPTION OF THE PREFERRED EMBODIMENT

The present invention is suitable for an assembled product particularly furniture product which has symmetrical left and right parts. The connecting holes of the left and right parts are engaged with respective holes defined in corresponding locations of the main body. Accordingly, the left and right parts are interchangeable with each other and thus, can be assembled onto the main body with ease. As a result, the assembled product in particular the furniture can be readily assembled as an entire product, hence improving production efficiency of the product especially the furniture.

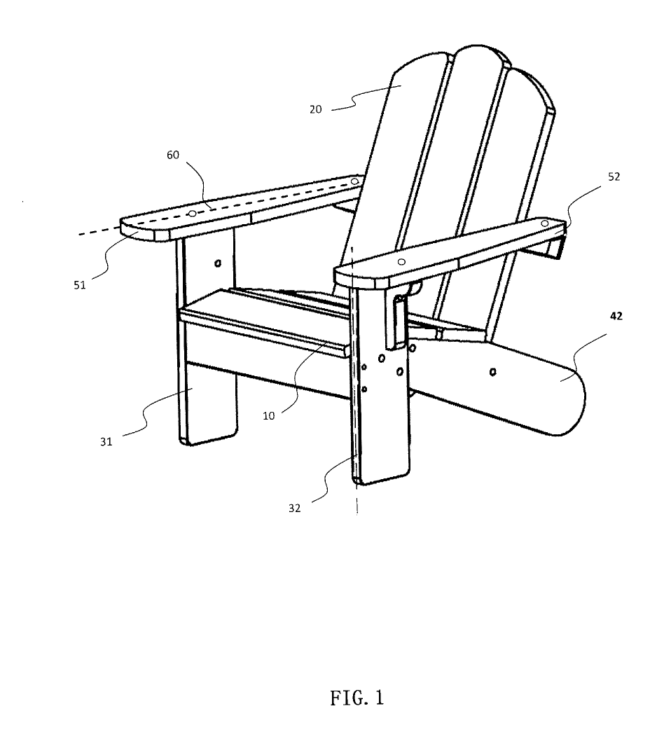

With reference to FIG. 1 and according to a preferred embodiment of the invention, the invention provides a garden chair which is symmetrical widthwise and has interchangeable left and right parts. The garden chair includes a seating plate 10; a backrest 20 coupled with the seating plate 10 at one side thereof; a pair of left and right front legs 31, 32 which are of the identical construction and coupled with the seating plate 10 symmetrically and respectively; a pair of left and right rear legs 42 which are of the identical construction and coupled with the seating plate 10 symmetrically and respectively; and a pair of left and right armrests 51 and 52 which are of the identical construction and coupled with the seating plate 10 symmetrically and respectively.

The present invention has some distinct differences with respect to prior art. The connecting holes of the left and right front legs 31, 32, the left and right rear legs 42 and left and right armrests 51, 52 are engaged with the corresponding connecting holes at corresponding locations of the seating plate 10 and/or backrest 20. All these parts are connected together by means of fasteners such as screws which are coupled with respective connecting holes in a threading manner.

The left and right front legs each has through connecting holes located on a middle line along thickness direction of the left or right front leg, and the left or right front leg is a symmetrical leg to a middle line along thickness direction.

The left and right rear legs each has through connecting holes located on a middle line along thickness direction of the left or right rear leg, and the left or right rear leg is a symmetrical leg to a middle line along thickness direction.

Additionally, in consideration of appearance of the furniture, the left and right armrests 51 and 52 may each have such a design that they are symmetrical along length direction of the corresponding armrest.

Further, the left and right armrests each has blind connecting holes defined therein, the left or right armrest are symmetrical armrests to a middle line along length direction of the left or right armrest.

Further, the left and right armrests each has through connecting holes located on a middle line along thickness direction of the left or right armrest, and the left or right armrest is a symmetrical armrest to a middle line along thickness direction.

It is noted that each left part and corresponding right part of the garden chair are interchangeable with each other. Taken as an example, the left front leg 31 can be replaced by the right front leg 32. The left rear leg 42 can be replaced by the right rear leg 42. The left armrest 51 is interchangeable with the right armrest 52. For example, the assembling position of the left front leg 31 with respect to the seating plate 10 can be used to assemble the right front leg 32, thus making the assembly more ease and improving largely the manufacture efficiency of the furniture.

What is claimed is:

1. An assembled product comprising:
a main body;
a left part and right part having same construction and being symmetrically mounted to the main body;
both side of the main body have connecting holes;
the left or right part has connecting holes corresponding to the connecting holes defined both side of the main body;
if the connecting holes are through holes located on a middle line in thickness direction of the left or right part, the left or right part is a symmetrical part to the middle line along thickness direction;
if the connecting holes are blind holes, the left or right part is a symmetrical part to the middle line along length direction;
thereby, the left part and right part can be exchange without worrying positions of connecting holes.

2. The assembled product according to claim 1, wherein the connecting holes are through holes located on a middle line along thickness direction of the left or right part, the left or right part is a symmetrical part to the middle line along thickness direction.

3. The assembled product according to claim 1, wherein the connecting holes are blind holes, the left or right part is a symmetrical part to the middle line along length direction;

4. The assembled product according to claim 1, wherein the assembled product is furniture.

5. An assembled garden chair comprising:
a seating plate;
a backrest assembled with the seating plate;
a pair of left and right front legs with an identical construction being assembled with both sides of the seating plate;
a pair of left and right rear legs with an identical construction being assembled with both sides of the seating plate;
the left and right front legs each has through connecting holes located on a middle line along thickness direction of the left or right front leg, and the left or right front leg is a symmetrical leg to the middle line along thickness direction;
the left and right rear legs each has through connecting holes located on a middle line along thickness direction of the left or right rear leg, and the left or right rear leg is a symmetrical leg to the middle line along thickness direction.

6. The garden chair according to claim 5, wherein the left and right front legs are symmetrical and the left and right rear legs are symmetrical.

7. The assembled garden chair according to claim 5, wherein the connecting holes of the left front leg is defined in locations along length direction thereof, the connecting holes of the right front leg is defined in locations along length direction thereof, the connecting holes of the left rear leg is defined in locations along length direction thereof, and the connecting holes of the right rear leg is defined in locations along length direction thereof.

8. The assembled garden chair according to claim 5, further comprising a pair of left and right armrests, which are of the identical configuration and are assemble with both side of the seating plate and backrest respectively.

9. The assembled garden chair according to claim 8, wherein the left and right armrests each has blind connecting holes defined therein, the left or right armrest are symmetrical armrests to a middle line along length direction of the left or right armrest.

10. The assembled garden chair according to claim 8, wherein the left and right armrests each has through connecting holes located on a middle line along thickness direction of the left or right armrest, and the left or right armrest is a symmetrical armrest to the middle line along thickness direction.
